(19) United States
(12) Patent Application Publication
(10) Pub. No.: US 2020/0267124 A1
(43) Pub. Date: Aug. 20, 2020

(54) METHOD FOR DETERRING MALICIOUS NETWORK TRAFFIC

(71) Applicant: Go-idea Ltd., Taichung (TW)

(72) Inventors: CHE-HUNG YEH, Tainan (TW); JIAN-TING HUANG, Taichung (TW); YUEH-FENG Lin, Taichung (TW)

(21) Appl. No.: 16/281,034

(22) Filed: Feb. 20, 2019

(51) Int. Cl. H04L 29/06; G06K 9/62; G06N 3/08

(52) U.S. Cl. CPC H04L 63/0245; G06K 9/6201; G06N 3/08; H04L 63/1416; H04L 63/1425; G06K 9/6256

(57) ABSTRACT

A method for deterring malicious network traffic heading for a data center from an external user via a cloud includes the step of receiving at least one packet of inline network traffic before the data center. Then, the packet of the inline network traffic is converted into at least one network traffic-related graphic. Then, the network traffic-related graphic is compared with model-related graphics. Then, it is determined whether the network traffic-related graphic matches any of the model-related graphics. A warning is provided or the packet of the inline network traffic is blocked if the network traffic-related graphic matches any of the model-related graphics. The packet of the inline network traffic is transferred to the data center if the network traffic-related graphic does not match any of the model-related graphics.

### BACKGROUND OF INVENTION

### 1. Field of Invention

The present invention relates to security of a network and, more particularly, to a method for deterring malicious network traffic by using a graphic processing technique to inspect packets.

### 2. Related Prior Art

To protect a computer system or a network from attacks, the networks monitored and malicious network traffic is deterred by defending means such as a web application firewall (‘WAF’), an intrusion-preventing system (‘IPS’), an intrusion-detecting system (‘IDS’) and an advanced threat-preventing (‘ATP’) technique. A typical method to monitor the internet is use the defending means to execute deep packet inspection (‘DPI’) on packets of inline network traffic to a host computer or data center. On finding a packet to include malicious-pattern data, the defending means immediately provides a warning and/or blocks malicious network traffic.

To inspect packets, packets of common attacks are analyzed, and malicious patterns are extracted from the packets and turned into signature-based or policy-based models for comparison. On finding a packet of network traffic to include a malicious pattern after comparing the packet with the models, the defending means immediately provides a warning or blocks the network traffic. The packets of the network traffic are compared with the models, one after another. The defending means gets less efficient as it uses more models. Thus, an attacker can finally paralyze the defending means, access to the data center or an end user.

As described above, to monitor a network and inspect network traffic, the DPI compares the packets of the network traffic with the models one after another. Hence, the work load on the defending means gets heavier as the defending means uses more models. Thus, the defending means gets less efficient and could be paralyzed. To solve this problem, currently, the specification and amount of the defending means are increased. However, this inevitably increases the cost in the defense.

The present invention is therefore intended to obviate or at least alleviate the problems encountered in prior art.

### SUMMARY OF INVENTION

An objective of the present invention is to provide an effective and inexpensive method for deterring at least one packet of inline network traffic toe data center from an external user via a cloud.

Another objective of the present invention is to provide inefficient and precise method for deterring at least one packet of inline network traffic toe data center from an external user via a cloud.

To achieve the foregoing objectives, the method includes the step of receiving at least one packet of inline network traffic before the data center. Then, the packet of the inline network traffic is converted into at least one network traffic-related graphic. Then, the network traffic-related graphic is compared with model-related graphics. Then, it is determined whether the network traffic-related graphic matches any of the model-related graphics. A warning is provided or the packet of the inline network traffic is blocked if the network traffic-related graphic matches any of the model-related graphics. The packet of the inline network traffic is transferred to the data center if the network traffic-related graphic does not match any of the model-related graphics.

Other objectives, advantages and features of the present invention will be apparent from the following description referring to the attached drawings.

### BRIEF DESCRIPTION OF DRAWINGS

The present invention will be described via detailed illustration of two embodiments referring to the drawings wherein:

FIG. 1 is a block diagram of a system for executing a method for deterring malicious network traffic according to the present invention;

FIG. 2 is a block diagram of a server of the apparatus shown in FIG. 1;

FIG. 3 is a block diagram of the apparatus shown in FIG. 1 in a model-training program;

FIG. 4 is a flow chart of a method for deterring malicious network traffic according to the first embodiment of the present invention; and

FIG. 5 is a flow chart of a method for deterring malicious network traffic according to the second embodiment of the present invention.

### DETAILED DESCRIPTION OF EMBODIMENTS

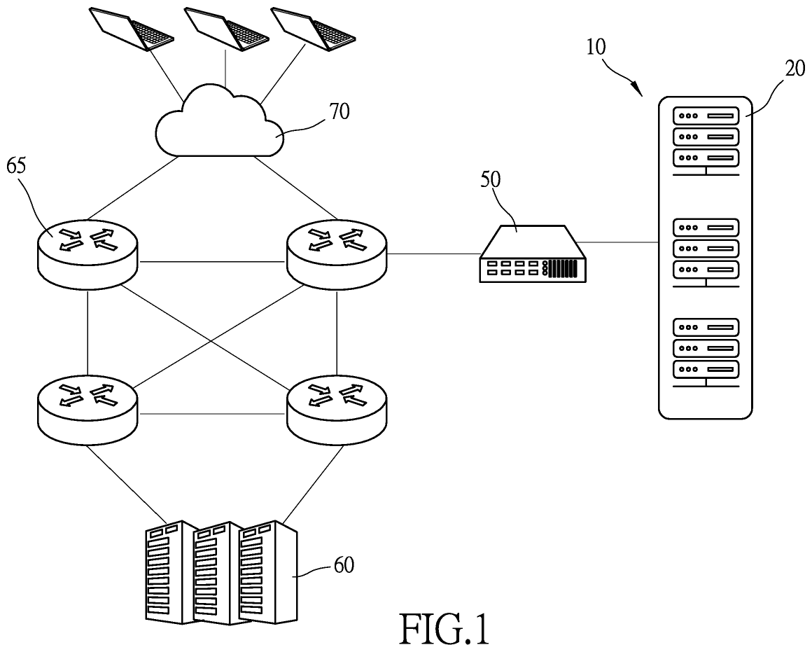

Referring to FIG. 1, there is shown a system for executing a method for deterring malicious network traffic according to the first embodiment of the present invention. The system includes a data center 60 connected to a cloud 70 via multiple routers 65. A deterring apparatus 10 is used to detect whether network traffic into the data center 60 from the cloud 70 contain malicious packets. The deterring apparatus 10 includes at least one analyzer server 20 and a tap switch 50. The analyzer server 20 is connected to the system via the tap switch 50. Thus, the analyzer 20 executes deep packet inspection (‘DPI’) on packets of the network traffic heading for the data center 60 via the routers 65. On finding any of the packets of network traffic to contain any malicious pattern, the analyzer server 20 immediately provides a warning and/or blocks the network traffic.

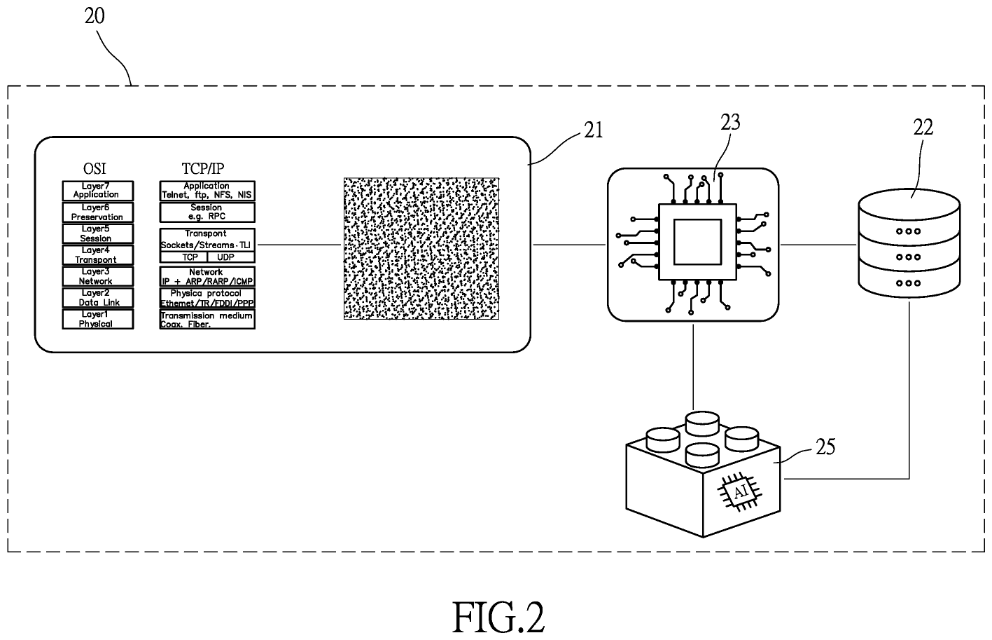

Referring to FIGS. 1 and 2, the analyzer server 20 includes at least one bitmap converter 21, at least one model-storing unit 22 and at least one graphics processing unit (‘GPU’) 23. The bitmap converter 21 converts a header and payload of data included in each of the packets of the network traffic into a network traffic-related graphic. The model-storing unit 22 stores model-related graphics derived from malicious or normal packets that are already known. The models derived from the known malicious packets are signature-based models in the preferred embodiment. The graphics processing unit 23 receives the network traffic-related graphics from the bitmap converter 2 land the model-related graphics from the model-storing unit 22. Then, the graphics processing unit 23 compares the network traffic-related graphics with the model-related graphics at high speed. To this end, the graphics processing unit 23 is connected to the bitmap converter 21 and the model-storing unit 22.

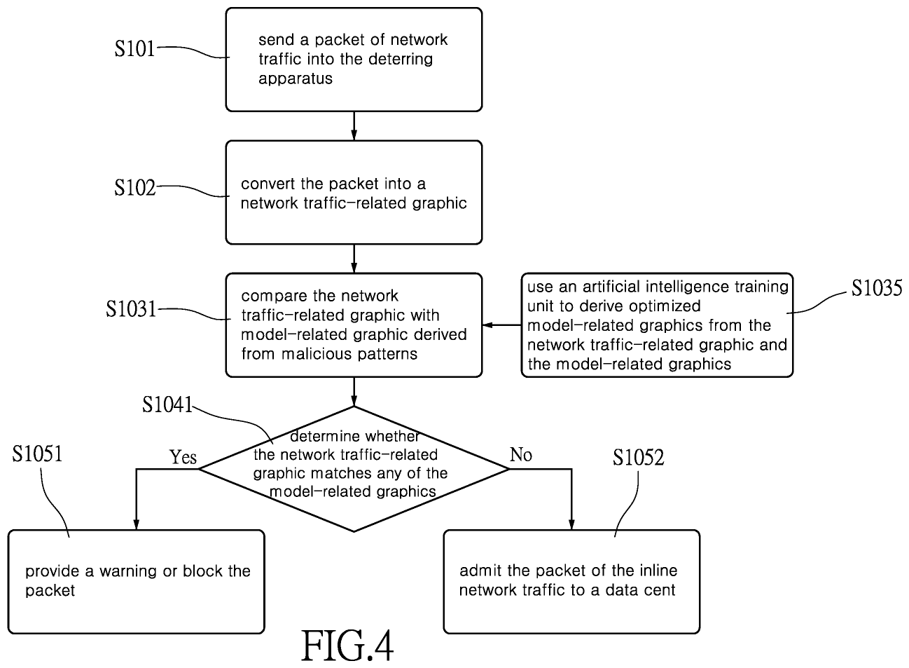

Referring to FIG. 4, the model-related graphics stored in the model-storing unit 22 are derived from the known malicious packets. In this case, a warning is provided and/or the network traffic is blocked if there is a match. The network traffic is admitted into the data center 60 if there is no match.

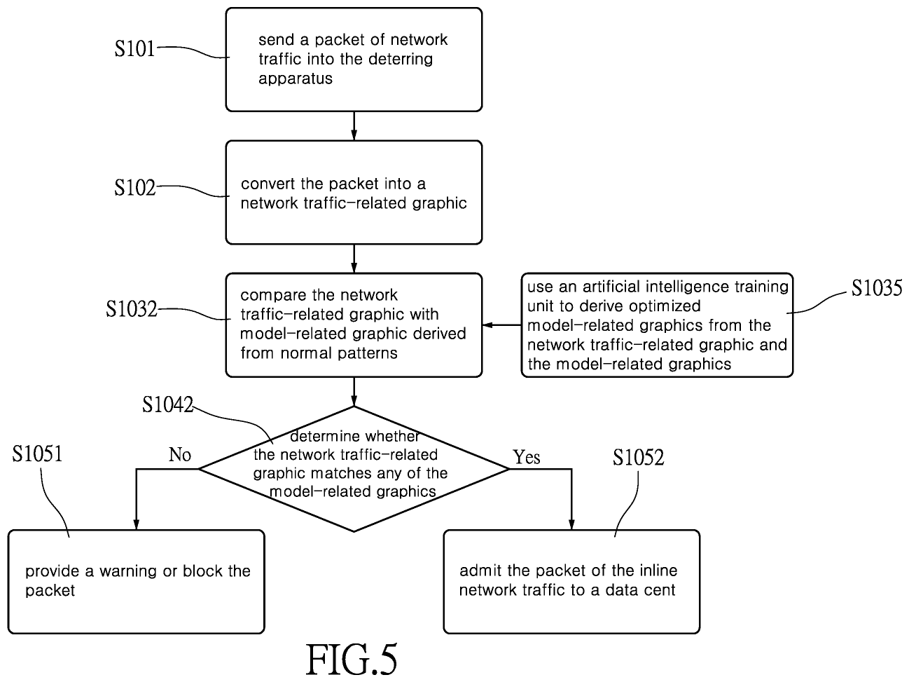

Referring to FIG. 5, the model-related graphics stored in the model-storing unit 22 are derived from the known normal packets. In this case, a warning is provided and/or the network traffic is blocked if there is no match. The network traffic is admitted into the data center 60 without taking any other action if otherwise.

Preferably, the analyzer server 20 further includes an artificial intelligence training unit 25 connected to the graphics processing unit 23 and the model-storing unit 22. The artificial intelligence training unit 25 can be a processor that includes a deep neural network such as DGX-1 of Nvidia and TPU of Google. The artificial intelligence training unit 25 executes training to derive optimized model-related graphics from the model-related graphics and the network traffic-related graphics. The optimized model-related graphics are sent to and stored in the model-storing unit 22. The optimized model-related graphics are to be used as model-related graphics with which a next network traffic-related graphic is to be compared. Thus, the precision of the comparison is improved and malicious packets can be detected effectively. Hence, security in the connection to awe is ensured.

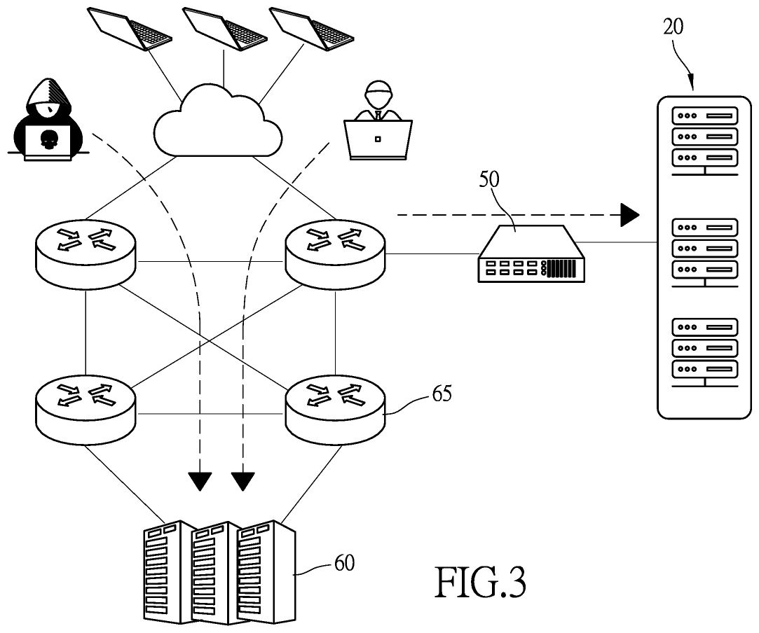

Referring to FIGS. 3 and 4, there is shown a method for deterring malicious packets. When the deterring apparatus 10 monitors an external user's access to the data center 60 via the cloud 70 and the routers 65, the analyzer server 20 of the deterring apparatus 10, which is connected to the routers 65 via the tap switch 50, executes the method to inspect inline network traffic.

At S101, a packet of network traffic is transmitted into the deterring apparatus 10. The packets of the network traffic are transferred to the analyzer server 20 of the deterring apparatus 10 via the tap switch 50.

Then, at S102, the deterring apparatus 10 converts the packet of the inline network traffic into a network traffic-related graphic. The bitmap converter 21 of the analyzer server 20 of the deterring apparatus 10 converts the packet of the inline network traffic into a network traffic-related graphic.

Then, at S1031, the network traffic-related graphic is compared with at least one model-related graphic derived from at least one malicious packet. The graphics processing unit 23 of the analyzer server 20 receives multiple original model-related graphics from the model-storing unit 22 in practice. Then, the graphics processing unit 23 compares the network traffic-related graphic with all the model-related graphics. In the first embodiment, the model-related graphics stored in the model-storing unit 22 are derived from known malicious packets.

Then, at S1041, it is determined whether the network traffic-related graphic matches any of the model-related graphics. The process goes to S1051 if the network traffic-related graphic matches any of the model-related graphics, and goes to S1052 if the network traffic-related graphic does not match any model-related graphic.

At S1051, a warning is provided or the packet of the inline network traffic is blocked. As mentioned above, the model-related graphics are derived from the known malicious packets. Hence, the deterring apparatus 10 determines the packet of the inline network traffic to be a malicious packet if finding the network traffic-related graphic to match any of the model-related graphics. Accordingly, the deterring apparatus 10 provides a warning and/or blocks the malicious packet of the inline network traffic from the data center 60. Synchronously, the deterring apparatus 10 writes data about the malicious packet in at least one log file.

At S1052, the packet of the inline network traffic is admitted to the data center 60, without any further action. The deterring apparatus 10 admits the packet of the inline network traffic to the data center 60 after determining that the network traffic-related graphic does not match any of the model-related graphics, without taking any further action.

Referring to FIG. 5, there is shown a deterring method in accordance with a second embodiment of the present invention. The second embodiment is identical to the first embodiment except for that the model-related graphics stored in the model-storing unit 22 are derived from normal packets.

At S101, the packets of inline network traffic are transmitted into the deterring apparatus 10. The packets of the network traffic are transferred to the analyzer server 20 of the deterring apparatus 10 via the tap switch 50.

Then, at S102, the deterring apparatus 10 converts the packets of the inline network traffic into at least one network traffic-related graphic. The bitmap converter 21 of the analyzer server 20 of the deterring apparatus 10 converts the packets of the inline network traffic into at least one network traffic-related graphic.

Then, at S1032, the network traffic-related graphic is compared with at least one model-related graphic derived from at least one normal packet. The graphics processing unit 23 of the analyzer server 20 receives model-related graphics from the model-storing unit 22. Then, the graphics processing unit 23 compares the network traffic-related graphic with all the model-related graphics. In the second embodiment, the model-related graphics stored in the model-storing unit 22 are derived from known normal packets.

Then at S1042, it is determined whether the network traffic-related graphic matches any of the model-related graphics. The process goes to S1051 if the network traffic-related graphic does not match any model-related graphic, and goes to S1052 if the network traffic-related graphic matches any of the model-related graphics.

At S1051, a warning is provided or the packet of the inline network traffic is blocked. As mentioned above, the model-related graphics are derived from normal packets. Hence, the deterring apparatus 10 determines the packet of the inline network traffic to be a malicious packet if finding the network traffic-related graphic not to match any of the model-related graphics. Accordingly, the deterring apparatus 10 provides a warning and/or blocks the malicious packet of the inline network traffic from the data center 60. Synchronously, the deterring apparatus 10 writes data about the malicious packet in at least one log file.

At S1052, the packet of the inline network traffic is admitted to the data center 60, without any further action. The deterring apparatus 10 admits the packet of the inline network traffic to the data center 60 after determining that the network traffic-related graphic matches any of the model-related graphics, without taking any further action.

The artificial intelligence training unit 25 can be included in another embodiment. After S1031 or S1032, the artificial intelligence training unit 25 trains to derive optimized model-related graphics from the network traffic-related graphic and the model-related graphics. Then, the artificial intelligence training unit 25 sends the optimized model-related graphics to the model-storing unit 22. The optimized model-related graphics are to be used as model-related graphics with which a next network traffic-related graphic is to be compared. Hence, at S1031 or S1032, the model-related graphics can be the original model-related graphics generated before any comparison or the original model-related graphics generated after a previous round of comparison.

In another embodiment, some of the model-related graphics stored in the model-storing unit 22 of the analyzer server 20 are derived from malicious packets and the other model-related graphics are derived from normal packets. Thus, the determination of whether a network traffic-related packet is a malicious packet is executed at an improved pace.

The present invention has been described via the illustration of the embodiments. Those skilled in the art can derive variations from the embodiments without departing from the scope of the present invention. Therefore, the embodiments shall not limit the scope of the present invention defined in the claims.

1. A method for deterring malicious network traffic heading for a data center from an external user via a cloud, the method comprising the steps of:
providing a deterring apparatus;
using the deterring apparatus to receive at least one packet of inline network traffic before the data center;
using the deterring apparatus to convert the packet of the inline network traffic into at least one network traffic-related graphic;
using the deterring apparatus to compare the network traffic-related graphic with model-related graphics;
using the deterring apparatus to determine whether the network traffic-related graphic matches any of the model-related graphics;
using the deterring apparatus to provide a warning or block the packet of the inline network traffic if the network traffic-related graphic matches any of the model-related graphics; and
using the deterring apparatus to transfer the packet of the inline network traffic to the data center if the network traffic-related graphic does not match any of the model-related graphics.

2. The method according to claim 1, wherein the step of providing a warning or blocking the packet of the inline network traffic comprises the step of writing data about the packet of the inline network traffic in a log file.

3. The method according to claim 1, wherein the step of comparing the network traffic-related graphic with the model-related graphic comprises the step of training to derive optimized model-related graphics from the model-related graphics and the network traffic-related graphic, and the optimized model-related graphics are to be used as model-related graphics with which a next network traffic-related graphic is to be compared.

4. A method for deterring malicious network traffic heading for a data center from an external user via a cloud, the method comprising the steps of:
providing a deterring apparatus;
using the deterring apparatus to receive at least one packet of inline network traffic before the data center;
using the deterring apparatus to convert the packet of the inline network traffic into at least one network traffic-related graphic;
using the deterring apparatus to compare the network traffic-related graphic with model-related graphics;
using the deterring apparatus to determine whether the network traffic-related graphic matches any of the model-related graphics;
using the deterring apparatus to provide a warning or block the packet of the inline network traffic if the network traffic-related graphic does not match any of the model-related graphics; and
using the deterring apparatus to transfer the packet of the inline network traffic to the data center if the network traffic-related graphic matches any of the model-related graphics.

5. The method according to claim 1, wherein the step of providing a warning or blocking the packet of the inline network traffic comprises the step of writing data about the packet of the inline network traffic in a log file.

6. The method according to claim 4, wherein the step of comparing the network traffic-related graphic with the model-related graphic comprises the step of training to derive optimized model-related graphics from the model-related graphics and the network traffic-related graphic, and the optimized model-related graphics are to be used as model-related graphics with which a next network traffic-related graphic is to be compared.

7. An apparatus for deterring malicious network traffic heading for a data center from an external user via a cloud, the apparatus comprising at least one analyzer server connected to routers of the data center via a tap switch, wherein the analyzer server comprises:
at least one bitmap converter for converting at least one packet of inline network traffic into a network traffic-related graphic;
at least one model-storing unit for storing model-related graphics; and
at least one graphics processing unit for comparing the network traffic-related graphic with the model-related graphic the graphic, providing a warning or blocking the packet of the inline network traffic at a first result of the comparison, and transferring the packet of the inline network traffic to the data center at a second result of the comparison.

8. The apparatus according to claim 7, wherein the model-related graphics stored in the model-storing unit are derived from malicious packets.

9. The apparatus according to claim 8, wherein the model-related graphics derived from the malicious packets are extracted from malicious patterns of the malicious packets.

10. The apparatus according to claim 7, wherein the model-related graphics stored in the model-storing unit are derived from normal packets.

11. The apparatus according to claim 7, wherein the analyzer server further comprises an artificial intelligence training unit connected to the graphics processing unit, and operable for deep training based on the model-related graphics to derive at least one model-related graphic from the model-related graphic.
